(19) United States
(12) Patent Application Publication
(10) Pub. No.: US 2005/0248663 A1
(43) Pub. Date: Nov. 10, 2005

(54) Systems and methods for responding to a data transfer

(76) Inventors: James Owens, Fort Collins, CO (US); James S. Voss, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/839,609

(22) Filed: May 5, 2004

(51) Int. Cl. H04N 5/228

(52) U.S. Cl. 348/222.1

(57) ABSTRACT

Systems and methods for responding to a data transfer are disclosed. One embodiment comprises a method that includes the following steps: retrieving an operator preference for a smooth representation or a sharp representation, determining a sustainable data transfer rate for streaming information to an auxiliary memory medium, selecting a set of operational parameters responsive to the operator preference and the sustainable data transfer rate, and applying the set of operational parameters to generate a data stream.

### BACKGROUND

Many consumer devices are now constructed to generate and/or use digital data in increasingly large quantities. Portable digital cameras for still and/or moving pictures, for example, generate large amounts of digital data representing still images, video clips, and for some devices audio tracks. To provide for this type of data storage application, the storage memory should be relatively low in cost for sufficient capacities of around 10 MB to 1 gigabyte (GB). The storage memory should also be low in power consumption (e.g., <<1 Watt) and have relatively rugged physical characteristics to cope with the portable battery powered operating environment. Preferably the memory should have a short access time (preferably less than one millisecond) and moderate transfer rate (e.g., 20 Mb/s).

One form of storage currently used for application in portable devices such as digital cameras is flash memory. Flash memory meets the desired mechanical robustness, power consumption, transfer, and access rate characteristics mentioned above. However, the read/write speeds of flash memory cards varies greatly from card to card, vendor to vendor, and for individual cards read/write speeds can degrade with age and/or use of the card. The variance in data transfer rates to/from a particular external memory medium can make certain features unavailable in such applications, for example streaming video at the highest resolution, frame rate, and image quality acquirable on a digital camera.

### SUMMARY

One embodiment of a digital camera comprises an image acquisition system configured to generate a data stream, a data processing system configured to receive and transform the data stream to generate a compressed data stream, a control configured to generate a variable user input, and a memory interface coupled to the data processing system. The memory interface is configured to feedback a sustainable data transfer rate to configuration logic. The configuration logic selects a value associated with at least one operational parameter of the digital camera in response to the variable user input and the sustainable data transfer rate.

Another embodiment is a method for dynamically processing data. The method comprises the following: determining a sustainable data transfer rate between a data appliance and an auxiliary memory medium, determining a user preference for a smooth representation versus a sharp representation, selecting a value for at least one operational parameter within the data appliance in response to the sustainable data transfer rate and the user preference, and processing data in accordance with the at least one operational parameter.

### BRIEF DESCRIPTION OF THE DRAWINGS

The present systems and methods for responding to a data transfer, as defined in the claims, can be better understood with reference to the following drawings. The components within the drawings are not necessarily to scale relative to each other, emphasis instead is placed upon clearly illustrating the principles of the systems and methods.

FIG. 1 is a block diagram illustrating an embodiment of a digital camera.

FIG. 2 is a schematic of an embodiment of a graphical user interface operable on the display of the digital camera of FIG. 1.

FIG. 3 is a flow diagram illustrating an embodiment of a method for responding to a data transfer that can be implemented by the digital camera of FIG. 1.

FIG. 4 is a flow diagram illustrating an alternative embodiment of a method for responding to a data transfer.

FIG. 5 is a flow diagram illustrating another embodiment of a method for responding to a data transfer.

FIG. 6 is a flow diagram illustrating an embodiment of a method for configuring a data appliance such as the digital camera of FIG. 1.

### DETAILED DESCRIPTION

Present systems and methods for responding to a data transfer measure or otherwise determine a sustainable data transfer rate between a data appliance such as a digital camera and an external memory medium. The sustainable data transfer rate is optimized for data transfers to/from a particular auxiliary/external memory medium when data is transferred to/from the data appliance at the sustainable data transfer rate. By measuring and responding to actual data transfer rates, improved data characteristics can be met while still streaming data to/from the memory medium. Data transfer calibration can be implemented at system start up and/or at other unobtrusive times during system operation as may be desired.

Sustained data transfer rates can be determined by forwarding a test file via a memory interface to an auxiliary/external memory medium. The test file contains a digital representation of video data. Any of a number of methods may be used to determine a sustainable data transfer rate for data write or data read operations. Described methods read or write the test file at an initial bit rate that matches the maximum rate supportable by the data appliance. If a data transfer error is detected, an interim bit rate less than the initial bit rate by a predetermined amount is used for the remainder of the data transfer and/or subsequent data transfers. After the bit rate has been decreased, the data transfer resumes until another data transfer error condition occurs or the data transfer is completed. Data transfers and bit rate adjustments repeat until no data error is detected during a transfer of the test file.

An alternative method starts with an initial bit rate that is slower than that required to support the transfer of the desired data stream directly to/from the external memory medium for a set of desired operational parameters. The test file is written to or read from the auxiliary/external memory medium at the initial bit rate. If a data transfer error is detected, a suitable error message indicating that the memory medium cannot support the desired data quality is communicated to an operator of the data appliance via a user interface. If no error condition is detected, the initial bit rate is increased by a predetermined amount and the test file is transferred again. The test file transfer, error condition monitoring, and bit rate adjustment steps are repeated until a data transfer error is detected or the data appliance reaches its maximum data transfer rate. When a data transfer error is encountered, the data appliance may use the last bit rate associated with a successful file transfer or may reduce the last bit rate by some other predetermined amount or by a predetermined percentage of the bit rate that produced the data transfer error. When the alternative bit rate adjustment is contemplated, the data appliance will be configured to confirm that the test file can be successfully transferred to/from the external memory medium at the final bit rate.

Additional methods for determining a sustainable data transfer rate between a data appliance and an auxiliary/external memory medium may be implemented within contemplated systems for responding to a data transfer. Select additional and previously described methods for determining a sustainable data transfer rate may be implemented for monitoring data write operations (i.e., data transfers to an external memory medium) with the same or different methods used for monitoring data read operations (i.e., data transfers from an auxiliary/external memory medium) as may be desired.

In addition to responding to a sustainable data transfer rate, present systems and methods retrieve and respond to an operator preference. In the example embodiment, the data appliance is a digital camera and the operator preference concerns whether an operator of the camera desires to stream video data that is smoother (i.e., at a higher frame rate so that objects in motion in the video representation appear to move in a continuous manner) rather than sharper (i.e., at a higher spatial resolution) as these video quality characteristics may be limited by the sustainable data transfer rate associated with the present memory medium coupled to the digital camera.

After a sustainable data transfer rate and the operator preference are determined, the systems and methods select a value for an operational parameter within the data appliance to maximize the quality of data that can be streamed to the memory medium. Operational parameters include data acquisition parameters and data processing parameters. Data acquisition parameters are those variables that determine the nature of the acquired data stream. Data acquisition parameters include spatial resolution and/or frame rate. Data processing parameters are those variables that determine the nature of data compression performed on the acquired data stream. Data processing parameters include bit rate, frame type, and search area for motion vectors. After determining the sustainable read/write speed of the current external memory card or other auxiliary memory medium in use and the operator preference, one or more values associated with operational parameters can be selected to dynamically match the data rate generated on the data appliance to the sustainable data transfer speed. Selection of values associated with operational parameters includes the selection of a predetermined set of operational parameters for a range of sustainable data transfer rates.

For example, if an operator of a digital camera selects a preference of “smoothest,” a high frame rate will be applied over high frame resolution and low quantization. If an operator selects a preference of “sharpest,” higher frame resolution and low quantization will be applied over a high frame rate. Thus, for a given sustained data transfer rate and user preference, the digital camera will apply a set of values associated with operational parameters (e.g., data acquisition and data processing settings) to controllably maintain the digital camera's ability to stream video data to a select memory medium.

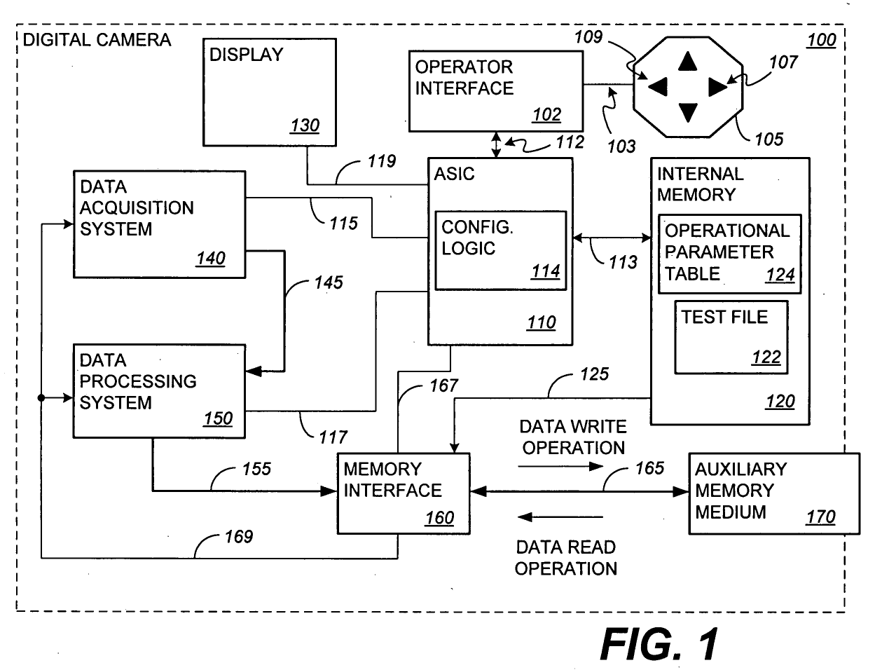

Turning to the drawings that illustrate various embodiments of systems and methods for responding to a data transfer, FIG. 1 is a block diagram illustrating an embodiment of an example digital camera 100. The embodiment illustrated in FIG. 1 includes a single arrangement of functional items configured to respond to a data transfer by selecting a value associated with at least one operational parameter in response to an operator preference and a sustained data transfer rate between the digital camera 100 and an auxiliary memory medium 170 coupled to the digital camera 100. It should be understood that digital camera 100 may include additional functional items not illustrated in FIG. 1 and that other arrangements of the illustrated functional items are possible. Digital camera 100, as illustrated in FIG. 1, includes an operator interface 102, control 105, application-specific integrated circuit (ASIC) 110, internal memory 120, display 130, data acquisition system 140, data processing system 150, and memory interface 160.

Operator interface 102 is coupled to control 105 via connection 103 and coupled to ASIC 110 via connection 112. Operator interface 102 coordinates the application of control inputs applied via control 105 at appropriate times under the direction of executable instructions stored in internal memory 120 and processed by ASIC 110. Control 105 includes a set of positional pushbuttons. The positional pushbuttons include right pushbutton 107 and left pushbutton 109.

ASIC 110 coordinates and controls the functions of the remaining functional items via various connections with each of the internal memory 120, display 130, data acquisition system 140, data processing system 150, and memory interface 160. As illustrated in FIG. 1, ASIC 110 is coupled to internal memory 120 via connection 113. ASIC 110 retrieves data and executable instructions, stores the same, and coordinates the transfer of data including operational parameters to/from the other functional items and internal memory 120 via connection 113. Operational parameters are distributed in accordance with configuration logic 114. Select values for operational parameters are included within operational parameter table 124 stored in internal memory 120. Specifically, operational parameter table 124 includes a set of suitable values for specified ranges of sustainable data transfer rates and operator preference for smooth/sharp video data.

ASIC 110 processes or otherwise executes executable instructions provided in firmware (not shown) within ASIC 110 or within software provided in internal memory 120. ASIC 110 further coordinates the transfer of display data via connection 119 to display 130.

Display 130 can be, for example, a liquid crystal display (LCD) or other display. Display data can include frames of image data. In alternative modes, display 130 presents camera configuration information, configuration menus, and other information. Display data can be formatted in ASIC 110 or in a display controller (not shown). The display data can be formatted using any of a number of standards including VGA, SVGA, among others.

Data acquisition system 140 is coupled to ASIC 110 via connection 115. Data acquisition system 140 is configured to obtain and forward data either via connection 115 to ASIC 110 or in alternative modes of operation to data processing system 150 via connection 145. Data acquisition system 140 captures or otherwise obtains data and forwards the acquired data in accordance with one or more data acquisition parameters. Data acquisition parameters may be stored internally within data acquisition system 140 or communicated to data acquisition system 140 at select times from ASIC 110 via connection 115.

For example, in one embodiment data acquisition system 140 is configured to capture image information. In this embodiment data acquisition system 140 includes an image sensor. The image sensor may comprise a charge coupled device (CCD) array or an array of complementary metal-oxide semiconductor (CMOS) sensors. Regardless of whether the image sensor comprises an array of individual CCD elements or CMOS sensors, each of the elements in the array comprises a picture element or pixel of the image sensor. The individual pixels of the image sensor are typically arranged in a two-dimensional array. For example, an array may comprise 2272 pixels in length and 1712 pixels in height.

The image sensor captures an image of a subject-of-interest by converting light incident upon the individual elements of the array into electrical signals. The electrical signals are forwarded to an analog-to-digital converter for converting the analog signal received from the image sensor into a digital signal. When data acquisition system 140 is configured to acquire image information over time, the data is acquired in accordance with a controllable spatial resolution and frame rate. Spatial resolution determines the number of pixels that will be used when forming a representation (e.g., a frame) of the captured image. A desired spatial resolution may or may not match the two-dimensional array of sensing elements in the image sensor. When the spatial resolution defines an array size that is lower than that provided by the image sensor, the data acquisition system 140 or ASIC 110 will drop some of the information provided by the image sensor. When the desired spatial resolution defines an array size that is higher than that provided by the image sensor, the data acquisition system 140 or ASIC 110 will insert data interpolated from closely located pixels to expand the size of the array. Frame rate determines the number of two-dimensional images provided over a fixed period of time (e.g., 30 frames/second).

A movie is usually filmed at a rate of 24 frames per second. This means that every second, there are 24 complete images displayed on the movie screen. American and Japanese television use the national television standards committee (NTSC) format, which displays a total of 30 frames per second in a sequence of 60 fields, each of which contains alternating lines of the picture. Other countries use the phase alternate line (PAL) format, which displays at 50 fields per second, but at a higher resolution. Because of the differences in frame rate and resolution, video data needs to be formatted for either the NTSC or the PAL system.

Data processing system 150 is coupled to ASIC 110 via connection 117. Data processing system 150 is configured to receive, format, or otherwise compress data from data acquisition system 140 via connection 145 or ASIC 110 via connection 117. Data processing system 150 formats and/or compresses data in accordance with one or more data processing parameters. Data processing parameters may be stored internally within data processing system 150 or communicated to data processing system 150 at select times from ASIC 110 via connection 117.

The compression and transmission of digital video is associated with a series of different disciplines of digital signal processing, each of which can be applied independently. Video data compression systems typically employ a variety of mechanisms to efficiently encode video frames. Some well-known compression standards (e.g., MPEG) utilize transform coding (e.g., the discrete-cosine transform), quantization, entropy coding, predictive coding, and control theory. Furthermore, these video compression standards contain a variety of different coding parameters and/or algorithms which may result in different performance depending on their values and/or implementation, respectively. When digital camera 100 is configured to acquire and process image information over time, the data is processed by data processing system 150 in accordance with a controllable bit rate, frame type, and search area for motion vectors. The bit rate reflects the amount of data transferred over a specific time period (e.g., 20 MB/second). The frame type defines how the image data for a specific frame is encoded. The search area defines the maximum displacement of matching blocks of information from one frame to the next, i.e., how objects can move between frames if they are to be coded effectively.

While most video compression techniques use some of the techniques used in compressing still image representations to eliminate redundant data, they also use information from other frames to reduce the overall size of a file or video clip. Each frame can be encoded in one of three ways: as an intraframe, a predictive frame, and a bidirectional frame. An intraframe contains the complete image data for that frame. This method of encoding provides the least compression. A predicted frame contains just enough information to display the frame based on the most recently displayed intraframe or predicted frame. This means that the frame contains only the data that relates to how the picture has changed from the previous frame. A bidirectional frame must have the information from the surrounding intraframe or predicted frames. Using data from the closest surrounding frames, it interpolates the position and color of each pixel.

Data processed in accordance with processing parameters is forwarded via connection 155 to memory interface 160. Memory interface 160 can store and retrieve data from an auxiliary memory medium 170 via connection 165. As illustrated in FIG. 1, data transfers from memory interface 160 to auxiliary memory medium 170 along connection 165 occur during data write operations. Data transfers from auxiliary memory medium 170 to memory interface 160 occur during data read operations. When in a compact flash form factor, auuxiliary memory medium 170 provides a mechanism for transferring acquired data from the digital camera 100.

Memory interface 160 is further coupled to internal memory 120 via connection 125 and ASIC 110 via connection 167. During a data transfer calibration operation, memory interface 160 retrieves test file 122 from internal memory 120 via connection 125. When a sustainable data write speed is desired, memory interface 160 forwards test file 122 at a predetermined bit rate. An internal system clock and monitoring logic (both not shown) associated with digital camera 100 are used to confirm bit rates associated with transfers of the test file 122. If a data transfer error occurs, memory interface 160 adjusts the bit rate until a sustainable data transfer rate is confirmed. Once confirmed, the sustainable data transfer rate for data write operations to the presently coupled auxiliary memory medium 170 is forwarded via connection 167 to ASIC 110.

When a sustainable data read speed is desired, memory interface 160 retrieves and forwards test file 122 to the auxiliary memory medium 170. Once the data transfer is complete, memory interface 160 begins to retrieve the test file 122 from auxiliary memory medium 170 at a predetermined bit rate. If a data transfer error occurs, memory interface 160 adjusts the bit rate until a sustainable data transfer rate is confirmed. The sustainable data transfer rate for data read operations from the presently coupled auxiliary memory medium 170 is forwarded via connection 167 to ASIC 110.

The systems and methods for responding to a data transfer can be implemented using combinations of hardware, software, or firmware. In the illustrated embodiment(s), the systems and methods are implemented using a combination of hardware and software that is stored in an internal memory and that is executed by a suitable instruction execution system provided within an ASIC.

Hardware components of the systems for responding to a data transfer can be implemented with any or a combination of the following alternative technologies, which are all well known in the art: discrete logic circuit(s) having logic gates for implementing logic functions upon data signals, an application specific integrated circuit (ASIC) having appropriate combinational logic gates (as described in the illustrated embodiment), a programmable gate array(s) (PGA), a field programmable gate array (FPGA), etc.

Software or firmware components of the systems for responding to a data transfer can be stored in one or more memory elements and executed by a suitable general purpose or application specific processor. Software or firmware for determining a sustainable data transfer rate and or for selecting a value for at least one operational parameter associated with a digital appliance and/or a digital camera, which comprises an ordered listing of executable instructions and data for implementing logical functions, can be embodied in any computer-readable medium for use by, or in connection with, an instruction execution system, apparatus, or device, such as an appropriately configured processor-containing camera or other system that can fetch the instructions from the instruction execution system and execute the instructions. While illustrated embodiments of the present systems and methods do not include operation with a computer, those of ordinary skill will understand that software or firmware components of the systems for responding to a data transfer can be stored on and later read from a computer-readable medium. In the context of this document, a “computer-readable medium” can be any means that can contain, store, communicate, propagate, or transport the program for use by or in connection with the instruction execution system.

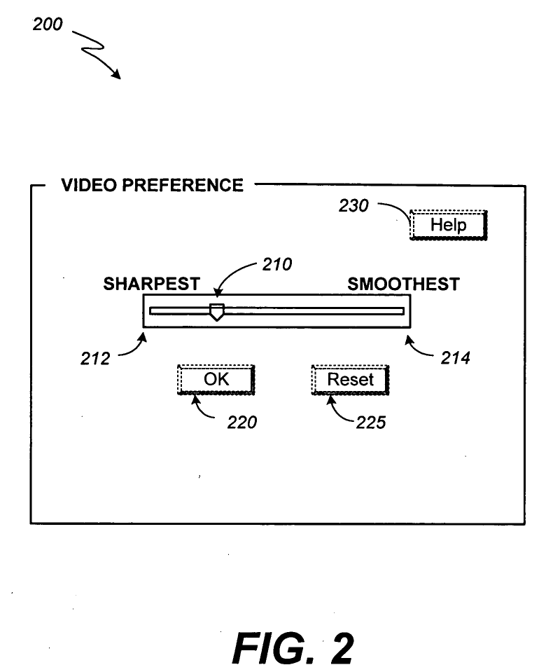

Reference is directed to FIG. 2, which illustrates an embodiment of a graphical user interface operable on the display 130 of the digital camera 100 of FIG. 1. As illustrated in FIG. 2, graphical-user interface 200 labeled “Video Preference,” includes a sliding bar 210. Sliding bar 210 is responsive to control inputs entered via operator interface 102 and control 105. Specifically, leftward movement, i.e., movement towards left-side limit 212 of sliding bar 210 is responsive to an operator depressing left pushbutton 109 associated with control 105. Relative leftward movement of sliding bar 210 results in an operator preference for sharper video data to be streamed to the present external memory medium coupled to the digital camera 100.

Similarly, rightward movement, i.e., movement towards right-side limit 214 of sliding bar 210 is responsive to an operator depressing right pushbutton 107 associated with control 105. Relative rightward movement of sliding bar 210 results in an operator preference for smoother video data to be streamed to the present external memory medium coupled to the digital camera 100.

As further illustrated in FIG. 2, graphical-user interface 200 may also include optional pushbuttons. For example, pushbutton 230 labeled, “Help,” when activated by an operator of the digital camera 100 results in the display of a help menu and/or information describing relative movement and application of a video preference via sliding bar 210. Pushbutton 225 labeled, “Reset,” when activated by an operator of the digital camera 100 sets the video preference to the value (i.e., position of the sliding bar 210) when graphical-user interface 200 was initially displayed. Pushbutton 220 labeled, “OK,” when activated by an operator of the digital camera 100 fixes the present location of sliding bar 210 and stores a corresponding value for the operator's video preference.

Once a preference has been entered and recorded or a default preference is retrieved from internal memory 120 and a sustainable data transfer rate is established and forwarded to ASIC 110, the configuration logic 114 within ASIC 110 determines a suitable set of values to apply to the operational parameters of digital camera 100. Configuration logic 114 compares the sustainable data transfer rate by type (i.e., data write, data read) and by speed against sets of predetermined operational parameter values suitable for operating the digital camera 100 across a range of operator preference levels for sharp/smooth representations and sustainable data rates. Once configuration logic 114 identifies the appropriate set of operational parameter values for the presently selected operator preference and sustainable data transfer rate, ASIC 110 forwards the values to the appropriate system. Thereafter, the digital camera 100 is configured to acquire, process, and stream video data to external memory medium 170. Note that one or more values associated with respective operational parameters may not change as a result of the application of a specific operator preference level for smooth/sharp video representations and a data transfer calibration.

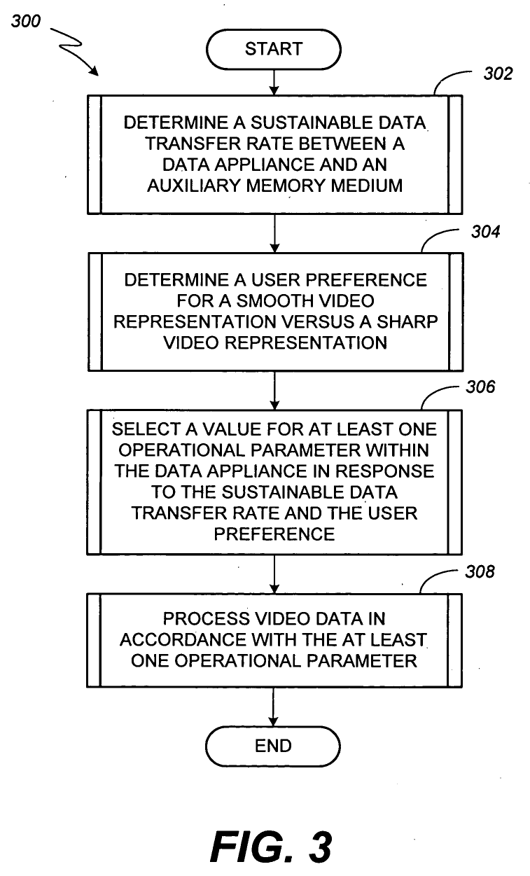

Any process descriptions or blocks in the flow diagrams illustrated in FIGS. 3-6 should be understood as representing steps in an associated process. Alternative implementations are included within the scope of the present methods for responding to a data transfer. For example, functions may be executed out-of-order from that shown or discussed, including substantially concurrently or in reverse order, depending on the functionality involved.

FIG. 3 is a flow diagram illustrating an embodiment of a method for responding to a data transfer that can be implemented by a data appliance such as the digital camera 100 of FIG. 1. As shown in FIG. 3, method 300 begins with block 302 where a sustainable data transfer rate for data transfers to and/or from an auxiliary memory medium is determined. In block 304, a user preference for a smooth video representation versus a sharp video representation is determined. It will be understood that the functions associated with blocks 302 and 304 may be executed out-of-order or substantially concurrently with one another. Although the term video is used to describe the captured data, it will be understood that data appliances, including some digital cameras support a burst mode where a plurality of images is captured over a brief duration of time. These burst modes are useful for viewing relative motion of objects-of-interest. Some other digital cameras support a mode where a series of images are captured and stored corresponding to a zoom in/out operation. Present systems and methods for responding to a data transfer are responsive to these as well as other data to be transferred to a memory medium.

After a sustainable data transfer rate is determined for the contemplated data transfer operation (e.g., a data write operation when transferring data from the respective device to the auxiliary memory medium) and a user preference is determined, a value for at least one operational parameter within the data appliance is selected in response to the sustainable data transfer rate and the user preference as indicated in block 306. Thereafter, as illustrated in block 308 video data is processed in accordance with the at least one operational parameter. Note that video data may or may not be processed in accordance with an operational parameter that was adjusted as a result of the application of the function associated with block 306. That is, video data may be acquired using one or more predetermined or default values for data acquisition parameters that match a select value(s). In addition, video data may be compressed using one or more predetermined or default values for data compression parameters that match a select value(s).

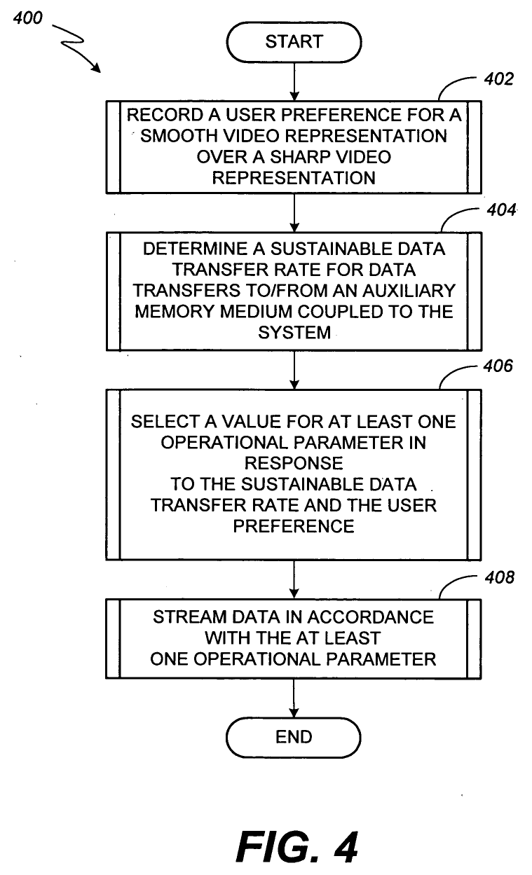

FIG. 4 is a flow diagram illustrating an alternative embodiment of a method for responding to a data transfer. As shown in FIG. 4, method 400 begins with block 402 where a user preference for a smooth video representation over a sharp video representation is recorded. In block 404, a sustainable data transfer rate for data transfers to and/or from an auxiliary memory medium is determined. It will be understood that the functions associated with blocks 402 and 404 may be executed out-of-order or substantially concurrently with one another.

After a sustainable data transfer rate is determined for the contemplated data transfer operation (e.g., a data write operation when transferring data from the respective device to the auxiliary memory medium) and the user preference is recorded, a value for at least one operational parameter is selected in response to the sustainable data transfer rate and the user preference as indicated in block 406. Thereafter, as illustrated in block 408 data is streamed in accordance with the at least one operational parameter and perhaps other operational parameters associated with digital camera 100. Note that data may or may not be streamed in accordance with an operational parameter that was adjusted as a result of the application of the function associated with block 406. That is, data may be acquired using one or more predetermined or default values for data acquisition parameters that match a select value(s). In addition, data may be compressed using one or more predetermined or default values for data compression parameters that match a select value(s).

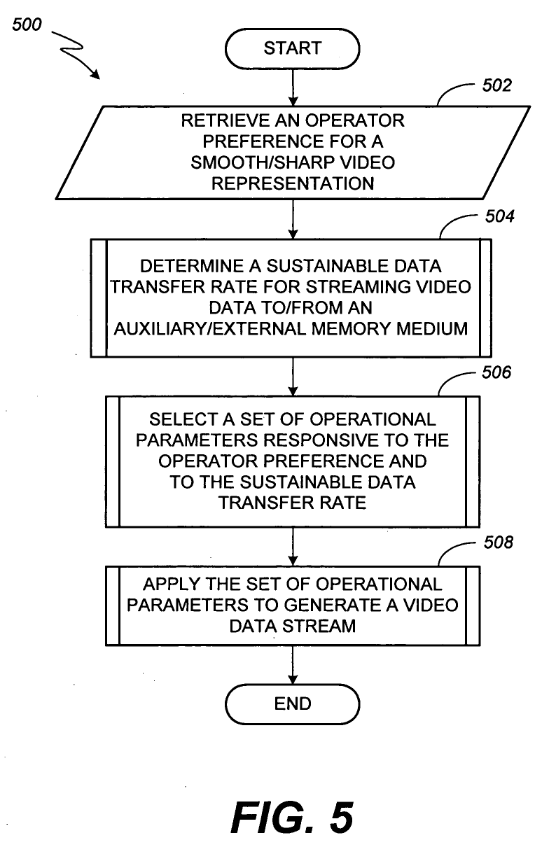

FIG. 5 is a flow diagram illustrating an embodiment of a method for responding to a data transfer that can be implemented by the digital camera 100 of FIG. 1. As shown in FIG. 5, method 500 begins with input/output block 502 where an operator preference for a smooth/sharp video representation is retrieved. In block 504 a sustainable data transfer rate for streaming video data to/from an auxiliary/external memory medium is determined. It will be understood that the functions associated with blocks 502 and 504 may be executed out-of-order or substantially concurrently with one another.

After a sustainable data transfer rate is determined for the contemplated data transfer operation (e.g., a data write operation when transferring data from the respective device to the external memory medium) and the operator preference is retrieved, a set of operational parameters responsive to the operator preference and the sustainable data transfer rate is selected as indicated in block 506. Thereafter, the set of operational parameters is applied to generate a video data stream as illustrated in block 508. Note that the video data stream may or may not be generated in accordance with an operational parameter that was adjusted as a result of the application of the function associated with block 506. That is, data may be acquired using one or more predetermined or default values for data acquisition parameters that match a select value(s). In addition, data may be compressed using one or more predetermined or default values for data compression parameters that match a select value(s).

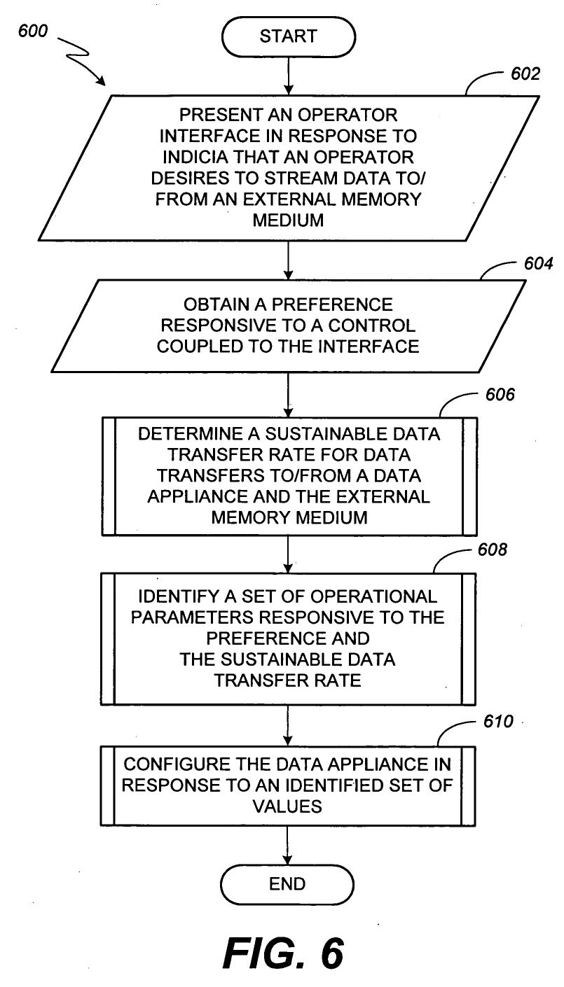

FIG. 6 is a flow diagram illustrating an embodiment of a method for configuring the digital camera of FIG. 1. As illustrated in FIG. 6, method 600 begins with input/output block 602 where an operator is presented an interface in response to an indication that the operator desires to stream data to/from an external memory medium. As indicated in input/output block 604, a preference is obtained responsive to a control coupled to the interface. In block 606, a sustainable data transfer rate for data transfers to/from a data appliance and the external memory medium is determined. It will be understood that the functions associated with blocks 602 and 604 may be executed out-of-order or substantially concurrently with the function associated with block 606.

Once the preference and the sustainable data transfer rate have been established, a set of operational parameters responsive to the preference and the sustainable data transfer rate are identified as indicated in block 608. Thereafter, as illustrated in block 610 the data appliance is configured in response to an identified set of values associated with the operational parameters. Note that the data appliance configuration may or may not be adjusted as a result of the application of the function associated with block 608. That is, the set of operational parameters selected may match predetermined or default values.

It should be emphasized that the above-described embodiments are merely examples of implementations of the systems and methods for responding to a data transfer. Many variations and modifications may be made to the above-described embodiments. All such modifications and variations are intended to be included herein within the scope of this disclosure and protected by the following claims.

1. A digital camera, comprising:
an image acquisition system configured to generate a data stream;
a data processing system configured to receive and transform the data stream to generate a compressed data stream;
a control configured to generate a variable user input; and
a memory interface configured to communicate a sustainable data transfer rate to configuration logic, wherein the configuration logic selects a value associated with at least one operational parameter of the digital camera in response to the variable user input and the sustainable data transfer rate.

2. The digital camera of claim 1, further comprising:
an image acquisition system responsive to at least one of spatial resolution and frame rate.

3. The digital camera of claim 1, further comprising:
a data processing system responsive to at least one of a desired bit rate, frame type, and search area for motion vectors.

4. The digital camera of claim 1, wherein the sustainable data transfer rate is responsive to a data write operation.

5. The digital camera of claim 1, wherein the sustainable data transfer rate is responsive to a data read operation.

6. The digital camera of claim 1, wherein the variable user input is forwarded to a graphical user interface.

7. The digital camera of claim 1, wherein the control is configured to convey a variable user preference for a smooth video representation to be streamed to an external memory medium coupled to the memory interface.

8. The digital camera of claim 1, wherein the control is configured to convey a variable user preference for a sharp video representation to be streamed to an external memory medium coupled to the memory interface.

9. A method for processing data, the method comprising the steps of:
determining a sustainable data transfer rate between a data appliance and an auxiliary memory medium;
determining a user preference for a smooth representation versus a sharp representation;
selecting a value for at least one operational parameter within the data appliance in response to the sustainable data transfer rate and the user preference; and
processing data in accordance with the at least one operational parameter.

10. The method of claim 9, wherein determining a sustainable data transfer rate between a data appliance and an auxiliary memory medium comprises transferring a test file between the data appliance and the auxiliary memory medium.

11. The method of claim 9, wherein determining a user preference comprises receiving an input from a user operable control coupled to the data appliance.

12. The method of claim 9, wherein selecting a value for at least one operational parameter comprises identifying a data acquisition parameter.

13. The method of claim 12, wherein processing data in accordance with the at least one operational parameter comprises acquiring and formatting image data.

14. The method of claim 12, wherein the data acquisition parameter comprises at least one of spatial resolution and frame rate.

15. The method of claim 9, wherein selecting a value for at least one operational parameter comprises identifying a data compression parameter.

16. The method of claim 15, wherein the data compression parameter comprises at least one of a bit rate, a frame type, and a search area for motion vectors.

17. The method of claim 9, wherein selecting a value for at least one operating parameter comprises applying a set of operational parameters.

18. A computer-readable medium having stored thereon an executable instruction set, the instruction set, when executed by a processor, directs the processor to perform a method comprising:
presenting an operator interface in response to indicia that an operator desires to stream data to/from an auxiliary memory medium;
obtaining a preference responsive to a control coupled to the interface;
determining a sustainable data transfer rate for data transfers to/from a data appliance and the auxiliary memory medium;
identifying a set of values for operational parameters of the data appliance responsive to the preference and the sustainable data transfer rate; and
configuring the data appliance in response to an identified set of values.

19. The computer-readable medium of claim 18, wherein presenting an operator interface comprises displaying a graphical user interface.

20. The computer-readable medium of claim 19, wherein the graphical user interface comprises a variable control.

21. The computer-readable medium of claim 18, wherein obtaining a preference comprises identifying whether an operator desires to stream data optimized in a particular manner.

22. The computer-readable medium of claim 18, wherein the operational parameters comprise at least one of an acquisition parameter and a data compression parameter.

23. The computer-readable medium of claim 22, wherein the acquisition parameter comprises one of spatial resolution and frame rate.

24. The computer-readable medium of claim 22, wherein the data compression parameter comprises at least one of a bit rate, frame type, and search area for motion vectors.

25. The computer-readable medium of claim 18, wherein identifying a set of values for operational parameters comprises applying a predetermined set of values responsive to a range of sustainable data transfer rates and a range of preferences.

26. A system for responding to a data transfer rate and a user input, comprising:
means for recording a user preference for a smooth representation over a sharp representation;
means for acquiring a data stream;
means for transforming the data stream;
means for determining a sustainable data transfer rate for data transfers to/from an auxiliary memory medium coupled to the system; and
means for adjusting at least one operational parameter associated with the means for acquiring or the means for transforming the data stream in response to the sustainable data transfer rate and the user preference.

27. The system of claim 26, wherein the means for recording a user preference comprises means for acquiring a variable user input.

28. The system of claim 26, wherein the means for acquiring a data stream is responsive to at least one acquisition parameter.

29. The system of claim 28, wherein the at least one acquisition parameter comprises one of spatial resolution and frame rate.

30. The system of claim 26, wherein the means for transforming the data stream is responsive to at least one processing parameter.

31. The system of claim 30, wherein the at least one processing parameter comprises a video data compression parameter.

32. The system of claim 31, wherein the video data compression parameter comprises one of a desired bit rate, frame type, and search area for motion vectors.

33. A computer-readable medium having stored thereon an executable instruction set, the instruction set, when executed by a processor, directs the processor to perform a method comprising:
retrieving an operator preference for a smooth/sharp representation;
determining a sustainable data transfer rate for streaming data to an auxiliary memory medium;
selecting a set of operational parameters responsive to the operator preference and the sustainable data transfer rate; and
applying the set of operational parameters to generate a data stream.

34. The computer-readable medium of claim 33, wherein determining a sustainable data transfer rate comprises retrieving a test file and an initial bit rate.

35. The computer-readable medium of claim 33, wherein selecting a set of operational parameters comprises selecting a set of at least one acquisition parameter and at least one data compression parameter.

36. The computer-readable medium of claim 35, wherein the at least one acquisition parameter comprises one of spatial resolution and frame rate.

37. The computer-readable medium of claim 35, wherein the at least one data compression parameter comprises at least one of a desired bit rate, frame type, and search area for motion vectors.
